(19) United States
(12) Patent Application Publication
(10) Pub. No.: US 2010/0111639 A1
(43) Pub. Date: May 6, 2010

(54) ANTIGALLING ANCHOR BOLT AND METHOD

(75) Inventor: PAUL GAUDRON, Stratford, CT (US)

Correspondence Address: CANTOR COLBURN, LLP, 20 Church Street, 22nd Floor, Hartford, CT, 06103, US

(73) Assignee: Powers Fasteners, Inc., Brewster, NY (US)

(21) Appl. No.: 12/263,934

(22) Filed: Nov. 3, 2008

(51) Int. Cl. F16B 29/00

(52) U.S. Cl. 411/354

(57) ABSTRACT

Disclosed is an anchor bolt including a wedge having a surface with a plurality of protrusions and a sleeve in operable communication with the surface. Furthermore, the sleeve is expandably receptive to the surface.

### BACKGROUND

Galling is a condition that can occur when two pieces of the same metal are rubbed together. Galling can be a problem if the two surfaces are intended to move relative to each other in use. Friction between the surfaces results in localized material transfer between the surfaces. Generally galling occurs when the two surfaces experience relative motion while subject to a sufficient compressive stress to permit the transfer of material. The stress between the surfaces tends to disrupt any protective oxide layer that is naturally present and allow metal-to-metal contact. Pure metal-to-metal contact without an oxide or other separating layer will facilitate a cold welding process thereby joining the surfaces together and preventing further relative motion therebetween.

Galling often occurs between an expander portion and an expansion sleeve of an anchor bolt when installing the anchor bolt into a base material. Depending upon the severity of the galling, the expander sleeve may be pulled from the base material rather than expanded properly by the expander portion of the bolt, thereby defeating the anchor. Additionally, galling increases the force required for removal of the anchor during intended disassembly. The art will be receptive to alternative configurations minimizing or eliminating galling.

### SUMMARY OF THE INVENTION

According to one aspect of the invention, an anchor bolt includes a wedge having a surface with a plurality of protrusions and a sleeve in operable communication with the surface, the sleeve expandably receptive to the surface.

According to another aspect of the invention, a method to reduce galling of an anchor bolt includes reducing contact area between a wedge surface and a sleeve of the anchor bolt.

According to yet another aspect of the invention, a method to reduce a breaking force between galled components of an anchor bolt includes, reducing contact area between a wedge surface and a sleeve of the anchor bolt.

### BRIEF DESCRIPTION OF THE FIGURES

The following descriptions should not be considered limiting in any way. With reference to the accompanying drawings, like elements are numbered alike:

FIG. 1 depicts a side view of an anchor bolt having a diamond knurled wedge according to an embodiment of the present invention;

FIG. 2 depicts a cross sectional side view of the anchor bolt of FIG. 1 at arrows 2-2;

FIG. 3 depicts a side view of an anchor bolt having a cross knurled wedge according to another embodiment of the present invention;

FIG. 4 depicts a side view of an anchor bolt having longitudinal ridges according to yet another embodiment of the present invention; and

FIG. 5 depicts a side view of an anchor bolt having latitudinal ridges according to still another embodiment of the present invention.

### DETAILED DESCRIPTION

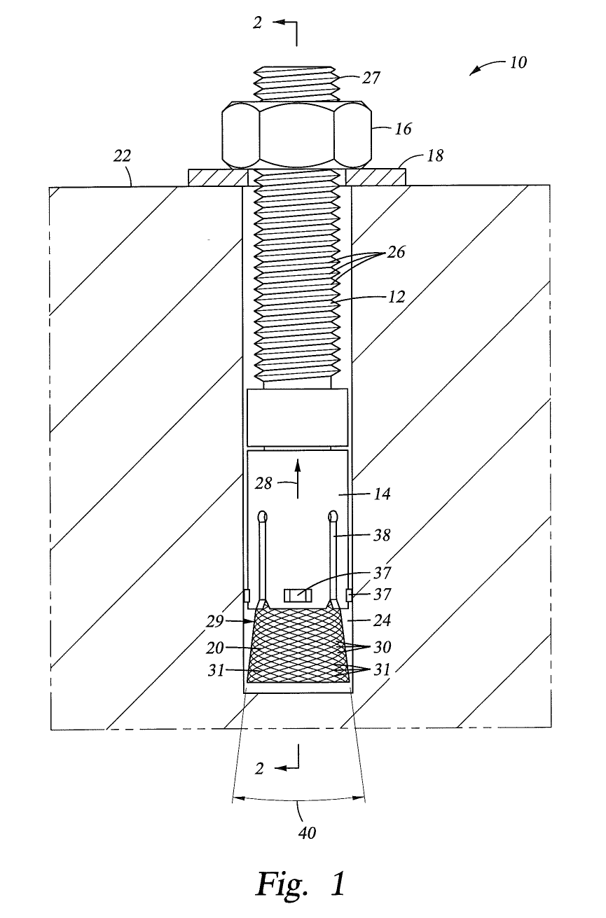

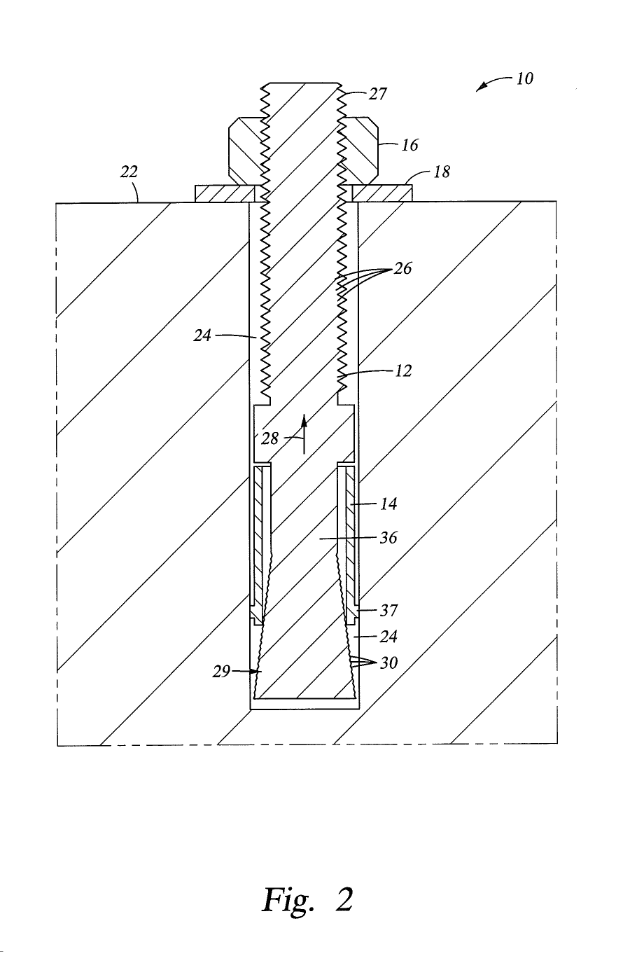

Referring to FIGS. 1-5, an embodiment of an anchor bolt 10 disclosed herein is shown. The anchor bolt 10 includes, a stud 12, a sleeve 14, a nut 16 and an optional washer 18. The stud has a wedge 20 that is configured to radially expand the sleeve 14 during setting of the anchor bolt 10 into a base material 22. To set the anchor bolt 10, the anchor bolt 10 is first inserted into a hole 24 made in the base material 22, the hole 24 having a diameter only slightly larger than that of the wedge 20. The nut 16 engages threads 26 on a portion 27 of the stud 12 that protrudes from the base material 22. Turning the nut 16 pulls the stud 12 and the wedge 20 in a setting direction as shown by arrow 28 while the sleeve 14 remains stationary in the base material 22 due to friction therebetween. As the wedge 20 moves in the direction of arrow 28, the sleeve 14 is expanded radially outwardly. Since the diameter of the hole 24 does not change appreciably due to the expansion input, the anchor bolt 10 becomes substantially anchored in the base material 22. In embodiments disclosed herein, an outer tapered surface 29 of the wedge 20 includes a plurality of protrusions 30. The protrusions 30 on the surface 29 reduce galling between the surface 29 and the sleeve 14 during setting. Additionally, in the event that some galling does occur, the existence of the protrusions 30 reduces a force needed to break the galled components apart.

The surface 29 of the wedge 20 has a generally tapered shape that may be conical for wedges 20 having a round cross section. Further, an angle 40 of the taper of the surface 29 may remain constant over a longitudinal length of the surface 29 as illustrated herein. Alternately, the angle 40 may be variable over the longitudinal length. Embodiments herein are not limited to being conical in shape, however, and may be any other shape that is effective in acting as a wedge.

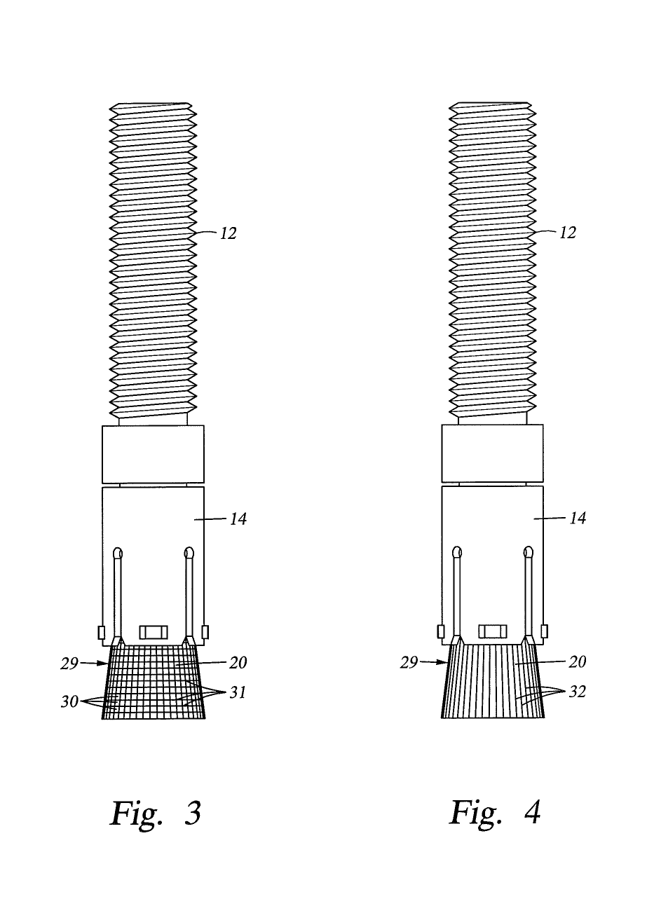

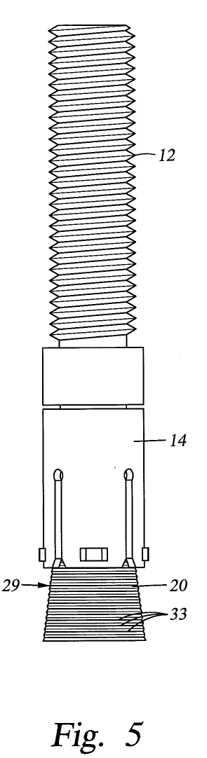

The surface 29 as shown includes a plurality of recessions 31 that correspond with the plurality of protrusions 30. The plurality of protrusions 30 may have a knurled pattern. In the example depicted in FIG. 1, the protrusions 30 have a diamond pattern. In other embodiments, the protrusions 30 may have a cross knurled pattern, as shown in FIG. 3, for example. Additionally, the protrusions 30 may be in the form of a series of longitudinal ridges 32, as shown in FIG. 4, or a series of latitudinal ridges 33, as shown in FIG. 5. Alternately, the protrusions 30 may not have any particular pattern. It should be understood that the protrusions 30 reduce the contact surface area between the surface 29 and the sleeve 14 during setting and may take any form that achieves this purpose.

As detailed above, the wedge 20 is in operable communication with the sleeve 14 during setting of the anchor bolt 10. In the embodiment shown in the Figures, the sleeve 14 is a fully bored formed cylindrical sleeve having an inner diameter 34 that is greater than the outer diameter 35 of a shank 36 of the anchor bolt 10. In this embodiment, the sleeve 14 is free to rotate around the shank 36 before setting. The sleeve 14 is also shown having the at least one gripping projection 37. The at least one gripping projection 37 helps to grip the base material 22 and increase friction between the sleeve 14 and the hole 24 during setting of the anchor bolt 10. The at least one gripping projection 37 is shown oriented in a latitudinal direction but may also be a longitudinal projection or may have a non-axial shape. Additionally, sleeve 14 is shown having at least one longitudinal slot 38 on the body of the sleeve 14. The at least one longitudinal slot 38 allows the sleeve 14 to be radially deflected without the necessity of stretching the material of the sleeve 14 itself In other embodiments, the sleeve 14 may be configured for being stretched.

It should be understood that the invention is not limited to the configurations depicted in the Figures. The anchor bolt 10 may be any anchor having a metallic wedge that expands a metallic portion of the anchor during setting. Furthermore, the stud 12 and the sleeve 14 may be fabricated of any metal susceptible to galling, such as, stainless steel, low carbon steel, cast iron, copper, aluminum, magnesium, and titanium, for example.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. An anchor bolt comprising:
a wedge having a surface with a plurality of protrusions; and
a sleeve in operable communication with the surface, the sleeve being expandably receptive to the surface.

2. The anchor bolt of claim 1, wherein the surface has a generally tapered shape.

3. The anchor bolt of claim 2, wherein the tapered shape is conical.

4. The anchor bolt of claim 1, wherein the surface has a constant angle of taper.

5. The anchor bolt of claim 1, wherein the surface has a varying angle of taper.

6. The anchor bolt of claim 1, wherein the sleeve perimetrically surrounds at least a portion of the wedge.

7. The anchor bolt of claim 1, wherein the plurality of protrusions have a corresponding plurality of recessions.

8. The anchor bolt of claim 1, wherein the plurality of protrusions are knurled.

9. The anchor bolt of claim 1, wherein the plurality of protrusions includes parallel ridges.

10. The anchor bolt of claim 1, wherein the plurality of protrusions includes a diamond pattern.

11. The anchor bolt of claim 1, wherein the plurality of protrusions includes a cross pattern.

12. The anchor bolt of claim 1, wherein the plurality of protrusions define a reduced contact area between the surface and the sleeve.

13. The anchor bolt of claim 11, wherein the reduced contact area defines an area of reduced galling bond strength.

14. The anchor bolt of claim 1, further comprising a threaded bolt portion.

15. A method to reduce galling of an anchor bolt comprising, reducing contact area between a wedge surface and a sleeve of the anchor bolt.

16. The method to reduce galling an anchor bolt of claim 15, wherein the reducing contact area includes knurling the wedge surface.

17. A method to reduce a breaking force between galled components of an anchor bolt comprising, reducing contact area between a wedge surface and a sleeve of the anchor bolt.

18. The method to reduce a breaking force between galled components of an anchor bolt of claim 17, wherein the reducing contact area includes knurling the wedge surface
